(19) United States
(12) Patent Application Publication
(10) Pub. No.: US 2017/0275525 A1
(43) Pub. Date: Sep. 28, 2017

(54) Methods To Make Ceramic Proppants

(71) Applicant: Halliburton Energy Services, Inc., Houston, TX (US)

(72) Inventors: Erik KOEP, Houston, TX (US); Hung TRUONG, Houston, TX (US); Jody Pham TRUONG, Houston, TX (US)

(73) Assignee: Halliburton Energy Services, Inc., Houston, TX (US)

(21) Appl. No.: 15/514,335

(22) PCT Filed: Oct. 5, 2015
(86) PCT No.: PCT/US2015/053985

§ 371 Date: Mar. 24, 2017

Related U.S. Application Data
(60) Provisional application No. 62/068,004, filed on Oct. 24, 2014.

(51) Int. Cl. C09K 8/80; C04B 41/85

(52) U.S. Cl. CPC C09K 8/805; C04B 41/85

(57) ABSTRACT

Included are methods to make ceramic proppants. The methods comprise coating green proppants with at least one reactive alumina or zirconium agent, such as gamma alumina. Also included are green proppants and liquid-phase sintered proppants made with the use of the reactive agent. Further included are uses for these proppants, such as in the oil and gas recovery areas.

### BACKGROUND

Provided are methods and systems to make proppants, including ceramic proppants, and more particularly to ceramic proppants having one or more desirable properties, including, but not limited to, ceramic proppants that avoid agglomeration during sintering and/or that have reduced or prevented diagenesis.

In forming ceramic proppants, generally, a green body is formed and then subjected to sintering. When solid-state sintering is used, generally, the materials forming the green body, during sintering remain as solids. However, when one or more components of the green body are capable of being subjected to liquid-phase sintering and the conditions during sintering permit liquid-phase sintering, unique issues to this type of sintering are encountered. This is especially true when rotary kilns are involved. Rotary kilns have seen limited use for liquid-phase sintering due to bonding problems and ring formation. Due to the rotation of the kiln, particles in a rotary kiln are constantly exposed to both the kiln walls and to other particles. A surface liquid-phase, such as those common during the first two stages of liquid-phase sintering, can cause the particles to become tacky. Without a surface coating or parting agent, the particles will then stick together and sinter, not as individual particles, but rather as a unit. Due to the rolling motion of the kiln, these agglomerates can grow quickly, resulting in the formation of “snowballs,” which are highly damaging both to other particles in the kiln and to the kiln itself.

Liquid-phase sintering, as opposed to solid state sintering, utilizes capillary forces to induce rearrangement and densification of the body. To achieve high density, wetting liquids are strongly preferred to non-wetting liquids as these will often reverse capillary forces and inhibit densification instead. While a wetting liquid-phase can greatly enhance densification at lower sintering temperatures, if the liquid-phase reaches the surface of the ceramic body during sintering, it can cause problems in cases where ceramic body interaction is common. Depending on the phase and chemical composition, a liquid that reaches the surface of the ceramic body during sintering may result in a tacky surface. This can cause the ceramic bodies to stick together and fuse into a larger single ceramic body rather than sinter as individual particles.

While some attempts have been made to combat this problem using physical or fugitive parting agents, these have not always been successful in preventing the “snowball” or agglomeration problems described above. Further, fugitive parting agents contribute nothing to the final product, contributing processing cost with little functional benefit.

Accordingly, there is a need to address these described problems with regard to bonding and the particles becoming tacky and thus sticking together to form “snowballs.”

### BRIEF DESCRIPTION OF DRAWINGS

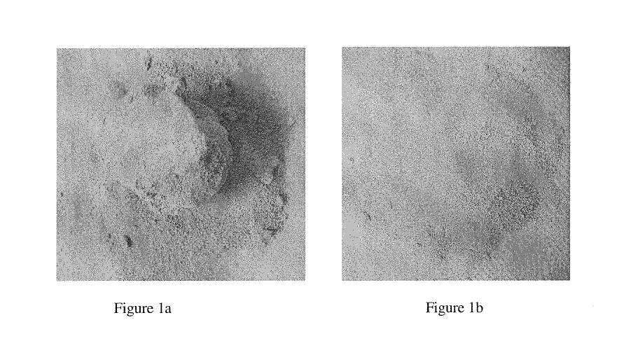

The drawings illustrate certain aspects of some examples of the present disclosure, and should not be used to limit or define the disclosure. FIGS. 1a and 1b are optical photographs of proppants fired without and with the reactive alumina agent coating respectively. Fusing is evident in the uncoated proppants and the fusing is significantly reduced in the coated proppants.

### DETAILED DESCRIPTION

Provided are methods and systems to make proppants, including ceramic proppants, and more particularly to ceramic proppants having one or more desirable properties, including, but not limited to, ceramic proppants that avoid agglomeration during sintering and/or that have reduced or prevented diagenesis. Examples involve the use of one or more reactive agents, such as one or more reactive alumina agents and/or reactive zirconium agents. These reactive agents have the ability to control, prevent, or reduce a surface liquid-phase from being exposed on the surface of the proppants which, in turn, then prevent the particles from becoming tacky and sticking together. One advantage of the disclosed examples is to provide a method to make ceramic particles that can avoid bonding problems during the sintering phase, especially when the sintering phase involves liquid-phase sintering. A further advantage is to provide a method that can form proppants and help reduce or prevent diagenesis.

Examples disclose a method to make ceramic proppants. The method comprises, consists essentially of, consists of, or includes coating, at least partially, a green proppant with a reactive agent(s) to form a coated green proppant. One or more reactive alumina agents can be used and/or one or more reactive zirconium agents can be used. The green proppant is a ceramic green proppant that comprises, consists essentially of, consists of, or includes at least aluminosilicate. The method further includes sintering the coated green proppant to form a sintered proppant. The sintering comprises, consists essentially of, consists of, or includes at least liquid-phase sintering.

With regard to the green proppant, the green proppant can be formed of one or more materials which generally include ceramic and/or glass components. The green proppant can be formed by any formation technique, such as extrusion, agglomeration, spray drying, spray coating, or other spheroid-forming techniques.

The green proppant generally contains or includes at least aluminosilicate, such as in an amount of from about 5 wt % to about 100 wt %, from about 10 wt % to about 90 wt %, from about 15 wt % to about 95 wt %, from about 20 wt % to about 95 wt %, from about 25 wt % to about 95 wt %, from about 35 wt % to about 95 wt %, from about 50 wt % to about 95 wt %, from about 60 wt % to about 95 wt %, or from about 70 wt % to about 95 wt %, based on the total weight percent of the green proppant.

The green proppant can contain one or more of the following ingredients and exemplary percentages are provided with the understanding that other amounts below and above these various weight percentages can be used.

As used herein, a “ceramic proppant” is a proppant that contains at least 90% by weight ceramic materials based on the entire weight of the ceramic proppant. For example, the ceramic proppant can contain at least 92% by weight ceramic materials, at least 95% by weight ceramic materials, at least 96% by weight ceramic materials, at least 97% by weight ceramic materials, at least 98% by weight ceramic materials, at least 99% by weight ceramic materials, at least 99.5% by weight ceramic materials, at least 99.9% by weight ceramic materials, or can be 100% by weight ceramic materials. The ceramic materials may be one or more metal oxides, and/or one or more non-oxides that are considered ceramics, such as carbides, borides, nitrides, and/or silicides. The term “ceramic” may include glass material, ceramic material, and/or glass-ceramic material and/or can comprise one or more glass, ceramic, and/or glass-ceramic phases. The “ceramic” material can be non-crystalline, crystalline, and/or partially crystalline.

The ceramic proppant may have less than 5 wt % polymeric and/or cellulosic (e.g., plant material or tree material). More preferably, the proppants may have less than 1 wt %, less than 0.5 wt %, less than 0.1 wt %, or 0 wt % of polymeric material or cellulosic material or both in the sintered proppants.

The ceramic in the ceramic proppants may be an oxide, such as aluminum oxides (alumina) and/or mixed metal aluminum oxides, such as metal aluminates containing calcium, yttrium, titanium, lanthanum, barium, and/or silicon in addition to aluminum. The ceramic can be an oxide, such as aluminum oxide called alumina, or a mixed metal oxide of aluminum called an aluminate, a silicate, or an aluminosilicate, such as mullite or cordierite. The aluminate or the ceramic in general may contain magnesium, calcium, yttrium, titanium, lanthanum, barium, and/or silicon. The ceramic may be formed from a nanoparticle precursor such as an alumoxane. Alumoxanes can be chemically functionalized aluminum oxide nanoparticles with surface groups including those derived from carboxylic acids such as acetate, methoxyacetate, methoxyethoxyacetate, methoxyethoxyethoxyacetate, lysine, and stearate, and the like. The ceramic can include, but is not limited to, boehmite, alumina, spinel, aluminosilicate clays (e.g., kaolin, montmorillonite, bentonite, and the like), calcium carbonate, calcium oxide, magnesium oxide, magnesium carbonate, cordierite, spinel, spodumene, steatite, a silicate, a substituted aluminosilicate clay or any combination thereof (e.g. kyanite) and the like.

The ceramic can be or contain cordierite, mullite, bauxite, silica, spodumene, clay, silicon oxide, aluminum oxide, sodium oxide, potassium oxide, calcium oxide, zirconium oxide, lithium oxide, iron oxide, spinel, steatite, a silicate, a substituted aluminosilicate clay, an inorganic nitride, an inorganic carbide or a non-oxide ceramic or any mixtures thereof. The proppant can include or be one or more sedimentary and/or synthetically produced materials.

Glass-ceramic, as used herein, refers to any glass-ceramic that is formed when glass or a substantially glassy material is annealed at elevated temperature to produce a substantially crystalline material, such as with limited crystallinity or controlled crystallite size. As used herein, limited crystallinity should be understood as crystallinity of from about 5% to about 100%, by volume (e.g., 10% to 90%; 20% to 80%; 30% to 70%; 40% to 60% by volume). The crystallite size can be from about 0.01 micrometers to 20 micrometers, such as 0.1 to 5 micrometers. Preferably the crystallite size is less than 1 micrometer. The glass-ceramic can be composed of aluminum oxide, silicon oxide, boron oxide, potassium oxide, zirconium oxide, magnesium oxide, calcium oxide, lithium oxide, phosphorous oxide, and/or titanium oxide or any combination thereof.

The glass-ceramic may comprise from about 35% to about 55% by weight SiO₂; from about 18% to about 28% by weight Al₂O₃; from about 1% to about 15% by weight (e.g., 1 to 5 wt %) CaO; from about 7% to about 14% by weight MgO; from about 0.5% to about 15% by weight TiO₂ (e.g., 0.5 to 5 wt %); from about 0.4% to about 3% by weight B₂O₃, and/or greater than 0% by weight and up to about 1% by weight P₂O₅, all based on the total weight of the glass-ceramic. The glass-ceramic can comprise from about 3% to about 5% by weight Li₂O; from about 0% to about 15% by weight Al₂O₃; from about 10% to about 45% by weight SiO₂; from about 20% to about 50% by weight MgO; from about 0.5% to about 5% by weight TiO₂; from about 15% to about 30% by weight B₂O₃, and/or from about 6% to about 20% by weight ZnO, all based on the total weight of the glass-ceramic.

The proppant can comprise aluminum oxide, silicon oxide, titanium oxide, iron oxide, magnesium oxide, calcium oxide, potassium oxide and/or sodium oxide, and/or any combination thereof. The sintered proppant can be or include at least in part cordierite, mullite, bauxite, silica, spodumene, silicon oxide, aluminum oxide, sodium oxide, potassium oxide, calcium oxide, zirconium oxide, lithium oxide, iron oxide, spinel, steatite, a silicate, a substituted aluminosilicate clay, an inorganic nitride, an inorganic carbide, a non-oxide ceramic or any combination thereof.

The glass-ceramic proppant can be fully or nearly fully crystalline or can contain a glass component (e.g., phase(s)) and a crystalline component (e.g., phase(s)) comprising crystallites. The glass-ceramic can have a degree of crystallinity of from about 5% to about 100%, or from about 15% to about 80%. For example, the glass-ceramic can have from about 50% to 80% crystallinity, from about 60% to 78% crystallinity or from about 70% to 75% crystallinity by volume. The crystallites can have a random and/or directed orientation. With respect to the orientation of the crystals that are present in the glass-ceramic, the crystal orientation of the crystals in the glass-ceramic can be primarily random or can be primarily directed in a particular orientation(s) (e.g., non-random). For instance, the crystal orientation of the glass-ceramic can be primarily random such that at least 50% or higher of the orientations are random orientations based on the overall orientation of the crystals present. For instance, the random orientation can be at least 60%, at least 70%, at least 80%, at least 90%, such as from about 51% to 99%, from 60% to 90%, from 70% to 95% or higher with respect to the percent of the crystals that are random based on the crystals measured. X-ray diffraction (“XRD”) can be used to determine the randomness of the crystallites. As the glass-ceramic can have both crystal and glass components, the glass-ceramic can have certain properties that are the same as glass and/or crystalline ceramics. Thus, the glass-ceramic can provide an ideal gradient interface between the template sphere and the ceramic shell, if present. The glass-ceramic can be impervious to thermal shock. Furthermore, the proportion of the glass and crystalline component of the glass-ceramic can be adjusted to match (e.g., within 10%, within 5%, within 1%, within 0.5%, within 0.1%) the coefficient of thermal expansion (CTE) of the shell (if present) or other material to which it will be bonded or attached or otherwise in contact with, in order to prevent premature fracture(s) resulting from cyclic stresses due to temperature changes, or thermal fatigue. For example, when the glass-ceramic has from 70% to 78% crystallinity, the two coefficients balance such that the glass-ceramic as a whole has a thermal expansion coefficient mismatch that is very close to zero.

Glass (which can be considered a ceramic type of material), as used herein, can be any inorganic, non-metallic solid non-crystalline material, such as prepared by the action of heat and subsequent cooling. The glass can be any conventional glass such as, for example, soda-lime glass, lead glass, or borosilicate glass. Crystalline ceramic materials, as used herein, can be any inorganic, non-metallic solid crystalline material prepared by the action of heat and subsequent cooling. For example, the crystalline ceramic materials can include, but are not limited to, alumina, zirconia, stabilized zirconia, mullite, zirconia toughened alumina, spinel, aluminosilicates (e.g., mullite, cordierite), perovskite, perchlorate, silicon carbide, silicon nitride, titanium carbide, titanium nitride, aluminum oxide, silicon oxide, zirconium oxide, stabilized zirconium oxide, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or any combination thereof.

The proppant can have a crystalline phase and a glass (or glassy) phase, or amorphous phase. The matrix or amorphous phase can include a silicon-containing oxide (e.g., silica) and/or an aluminum-containing oxide (e.g., alumina), and optionally at least one iron oxide; optionally at least one potassium oxide; optionally at least one calcium oxide; optionally at least one sodium oxide; optionally at least one titanium oxide; and/or optionally at least one magnesium oxide, or any combinations thereof. The matrix or amorphous phase can contain one or more, or all of these optional oxides in various amounts where, preferably, the silicon-containing oxide is the major component by weight in the matrix and/or the amorphous phase, such as where the silicon-containing oxide is present in an amount of at least 50.1% by weight, at least 75% by weight, at least 85% by weight, at least 90% by weight, at least 95% by weight, at least 97% by weight, at least 98% by weight, at least 99% by weight (such as from 75% by weight to 99% by weight, from 90% by weight to 95% by weight, from 90% by weight to 97% by weight) based on the weight of the matrix or based on the weight of the amorphous phase alone. Exemplary oxides that can be present in the amorphous phase include, but are not limited to, SiO₂, Al₂O₃, Fe₂O₃, Fe₃O₄, K₂O, CaO, Na₂O, TiO₂, and/or MgO. It is to be understood that other metals and/or metal oxides can be present in the matrix or amorphous phase.

The amorphous phase can include or be ceramic, and for instance can include alumina and/or silica. The amorphous phase can further include unreacted material (e.g., particles), such as alumina, alumina precursor, and/or siliceous material or any combination thereof.

The proppant can include one or more minerals and/or ores, one or more clays, and/or one or more silicates, and/or one or more solid solutions. The minerals or ores can be aluminum-containing minerals or ores and/or silicon-containing minerals or ores. These minerals, ores, clays, silicates, and/or solid solutions can be present as particulates. These component(s) can be present as at least one crystalline particulate phase that can be a non-continuous phase or continuous phase in the material. More specific examples include, but are not limited to, alumina, aluminum hydroxide, bauxite, gibbsite, boehmite or diaspore, ground cenospheres, fly ash, unreacted silica, silicate materials, quartz, feldspar, zeolites, bauxite and/or calcined clays. These components in a combined amount can be present in the material in an amount, for instance, of from 0.001 wt % to 85 wt % or more, such as from 1 wt % to 80 wt %, 5 wt % to 75 wt %, 10 wt % to 70 wt %, 15 wt % to 65 wt %, 20 wt % to 60 wt %, 30 wt % to 70 wt %, 40 wt % to 70 wt %, 45 wt % to 75 wt %, 50 wt % to 70 wt %, 0.01 wt % to 10 wt %, 0.1 wt % to 8 wt %, 0.5 wt % to 5 wt %, 0.75 wt % to 5 wt %, 0.5 wt % to 3 wt %, 0.5 wt % to 2 wt % based on the weight of the material. These amounts and ranges can alternatively apply to one crystalline particulate phase, such as alumina or an aluminum-containing material. These additional components can be uniformly dispersed throughout the matrix or amorphous phase (like filler is present in a matrix as discrete particulates).

The proppant can have any particle size. For instance, the proppant can have a particle diameter size of from about 75 microns to 1 cm or a diameter in the range of from 100 microns to about 2 mm, or a diameter of from about 100 microns to about 3,000 microns, or a diameter of from about 100 microns to about 1,000 microns. Other particle sizes can be used. Further, the particle sizes as measured by their diameter can be above the numerical ranges provided herein or below the numerical ranges provided herein.

The proppant can have any median particle size, such as a median particle size, dₚ₅₀, of from about 90 μm to about 2000 μm (e.g., from 90 μm to 2000 μm, from 100 μm to 2000 μm, from 200 μm to 2000 μm, from 300 μm to 2000 μm, from 500 μm to 2000 μm, from 750 μm to 2000 μm, from 100 μm to 1000 μm, from 100 μm to 750 μm, from 100 μm to 500 μm, from 100 μm to 250 μm, from 250 μm to 2000 μm, from 250 μm to 1000 μm), wherein dₚ₅₀ is a median particle size where 50% of the particles of the distribution have a smaller particle size.

The proppants of the present application can, for instance, have a specific gravity of from about 0.6 g/cc to about 4 g/cc. The specific gravity can be from about 1.0 g/cc to about 3 g/cc or can be from about 0.9 g/cc to about 2.5 g/cc, or can be from 1.0 g/cc to 2.5 g/cc, or from 1.0 g/cc to 2.4 g/cc, or from 1.0 g/cc to 2.3 g/cc, or from 1.0 g/cc to 2.2 g/cc, or from 1.0 g/cc to 2.1 g/cc, or 1.0 g/cc to 2.0 g/cc. Other specific gravities above and below these ranges can be obtained. The term “specific gravity” as used herein is the weight in grams per cubic centimeter (g/cc) of volume, excluding open porosity in determining the volume. The specific gravity value can be determined by any suitable method known in the art, such as by liquid (e.g., water or alcohol) displacement or with a gas pycnometer.

The proppant (green body and/or sintered proppant) can be spherical and have a Krumbein sphericity of at least about 0.5, at least 0.6 or at least 0.7, at least 0.8, or at least 0.9, and/or a roundness of at least 0.4, at least 0.5, at least 0.6, at least 0.7, or at least 0.9. The term “spherical” can refer to roundness and sphericity on the Krumbein and Sloss Chart by visually grading 10 to 20 randomly selected particles. Optionally, the proppants may have a very high degree of sphericity. In particular, the Krumbein sphericity can be at least 0.92, or at least 0.94, such as from 0.92 to 0.99, or from 0.94 to 0.99, or from 0.97 to 0.99, or from 0.95 to 0.99. This is especially made possible by the disclosed example methods, including forming synthetic templates on cores and using a spray dryer or similar device.

With regard to the proppant (either in the green body state or as a sintered proppant or both), the proppant has a change in sphericity of 5% or less. This change in sphericity parameter is with respect to the proppant (either in the green body state or sintered proppant state) in the shape of a sphere and this change in sphericity parameter refers to the uniformity of the sphere around the entire surface area of the exterior of the sphere. Put another way, the curvature that defines the sphere is very uniform around the entire sphere such that the change in sphericity compared to other points of measurement on the same sphere does not change by more than 5%. More preferably, the change in sphericity is 4% or less or 3% or less, such as from about 0.5% to 5% or from about 1% to about 5%.

The proppants may have a crush strength of 1,000 psi to 20,000 psi or higher (e.g., from 1,500 psi to 10,000 psi, from 3,000 psi to 10,000 psi, from 5,000 psi to 10,000 psi, from 9,000 psi to 12,000 psi). Other crush strengths below or above these ranges are possible. Crush strength can be measured, for example, according to American Petroleum Institute Recommended Practice 60 (RP-60) or according to ISO 13503-2.

The proppant can have a flexural strength in a range of from about 1 MPa to about 800 MPa, or more, such as 1 MPa to 700 MPa, 5 MPa to 600 MPa, 10 MPa to 500 MPa, 25 MPa to 400 MPa, 50 MPa to 200 MPa, and the like.

The proppant or part thereof can have a coefficient of thermal expansion (CTE at from 25° C. to 300° C.) of from about 0.1×10⁻⁶/K to about 13×10⁻⁶/K, such as from 0.1×10⁻⁶/K to 2×10⁻⁶/K or 1.2×10⁻⁶/K to 1.7×10⁻⁶/K. The proppant can have a MOR of from about 1 to about 800 MPa, such as 100 to 500 MPa.

The proppant can have a core and optionally at least one shell surrounding or encapsulating the core. The core can comprise, consist essentially of, or consist of one or more ceramic materials and/or oxides. The shell can comprise, consist essentially of, or consist of at least one ceramic material and/or oxide. The examples of various ceramic materials or oxides thereof provided above can be used here in this proppant. The sintered proppant can have a core strength to shell strength ratio of from 0.8 to 1. As an option, the proppant can have an overall proppant strength to core strength ratio of 2 to 3. The reference to core strength is based on the strength measurement of the core alone without any shell, for instance, as tested in a crush strength measurement, for instance, according to API Recommended Practice 60 (RP-60). The shell strength is determined by diameteral splitting tensile strength test method based on ASTM C1144, Modulus of Rupture test based on ASTM C78, or Modulus of Rupture test based on ASTM C1609. Similarly, the overall proppant strength is based on the proppant with the core and shell tested for crush strength compared to the core strength alone. Optionally, the core strength is equal to the shell strength, and can be below (lower than) the shell strength, and can be significantly below. The shell can be formed by a plurality of particles which are formed as a ceramic coating around or encapsulating the core and sintered to form a sintered continuous shell.

The plurality of green and/or sintered ceramic proppants can have a monodispersed size which means that the production of the proppants from a process produces monodispersed proppants without the need for any classification. Also, a plurality of green and/or sintered ceramic proppants having a monodispersed distribution that is at least a 3-sigma distribution means that the plurality of green and/or sintered ceramic proppants is not achievable by standard air classification or sieving classification techniques. The “plurality,” can refer to at least 1 kilogram of proppant, such as at least 5 kilograms, at least 10 kilograms, at least 50 kilograms, or at least 100 kilograms of proppant or other amounts.

With regard to the plurality of sintered ceramic proppants, it is understood that the sintered ceramic proppants are preferably synthetically prepared. In other words, all components of the proppants are formed by processing into a desired green body shape that is ultimately sintered. Put another way, the sintered proppants may not have any naturally preformed spheres present (e.g., no preformed cenospheres), unless it is ground to particle sizes for use in forming the green body, or a part thereof. Thus, as an option, the sintered ceramic proppants may be considered to be synthetically formed.

With regard to the reactive agent, the reactive agent is one that has the ability or capability to react with at least a portion of a glass phase that forms in the proppant during sintering. These reactive agents can have the ability to control, prevent, or reduce a surface liquid-phase from being exposed on the surface of the proppants which, in turn, then prevent the particles from becoming tacky and sticking together. As examples, one or more reactive alumina agents can be used and/or one or more reactive zirconium agents can be used. The reactive alumina agent can contain alpha alumina (e.g., as a phase) but the reactive alumina agent is not 100% by weight alpha alumina. To be a reactive alumina agent, an amount of non-alpha alumina (e.g., as a phase or as particles) must be present amongst the alumina used. Thus, the reactive alumina agent can comprise, consist of, consist of, or include about 90% or less by weight alpha alumina, less than 85% by weight alpha alumina, less than 80% by weight alpha alumina, less than 70% by weight alpha alumina, less than 60% by weight alpha alumina, less than 50% by weight alpha alumina, less than 40% by weight alpha alumina, less than 30% by weight alpha alumina, less than 20% by weight alpha alumina, less than 10% by weight alpha alumina, less than 5% by weight alpha alumina, and even lower amounts, such as 1% by weight or 0% by weight. These weight percents are based on the total weight of the reactive alumina agent. The reactive alumina agent can comprise, consist essentially of, consist of, or include smelter-grade alumina.

The reactive alumina agent can comprise, consist essentially of, consist of, or include at least 10% by weight non-alpha alumina, at least 15% by weight non-alpha alumina, at least 20% by weight non-alpha alumina, at least 25% by weight non-alpha alumina, at least 30% by weight non-alpha alumina, at least 40% by weight non-alpha alumina, at least 50% by weight non-alpha alumina, at least 60% by weight non-alpha alumina, at least 70% by weight non-alpha alumina, at least 80% by weight non-alpha alumina, at least 90% by weight non-alpha alumina, at least 95% by weight non-alpha alumina, or higher amounts, such as 98% by weight or 100% by weight non-alpha alumina, based on the total weight of the reactive alumina agent.

The reactive alumina agent can be or include gamma alumina and/or delta alumina, and/or theta alumina, and/or kappa alumina, and/or chi alumina, and/or eta alumina or any combinations thereof. One or more of these alumina can be present as phases and/or as particles. The reactive alumina agent can comprise, consist essentially of, consist of, or include at least 10 wt % gamma alumina, at least 15 wt % gamma alumina, at least 20 wt % gamma alumina, at least 30 wt % gamma alumina, at least 40 wt % gamma alumina, at least 50 wt % gamma alumina, at least 70 wt % gamma alumina, at least 80 wt % gamma alumina, at least 90 wt % gamma alumina, at least 95 wt % gamma alumina, or 100 wt % gamma alumina based on the total weight of the reactive alumina agent. These amounts and ranges can apply equally to each of the delta alumina and/or theta alumina, and/or kappa alumina and/or chi alumina and/or eta alumina or any combinations thereof.

The reactive alumina agent can comprise, consist essentially of, consist of, or include at least one non-alpha hydrated alumina. The amounts can be the same as mentioned above for the reactive alumina agent.

The reactive zirconium agent can be zirconium silicate, or zirconium oxide or both. A material that contains a few or more percent (e.g., 1 wt % to 100 wt %, 5 wt % to 95 wt %, 10 wt % to 90 wt %, 15 wt % to 85 w %, 20 wt % to 80 wt %, 30 wt % to 70 wt % and the like, based on the weight of the material) of the zirconium silicate and/or zirconium oxide can be used.

With regard to coating the green proppant with the reactive agent to form a coated green proppant, this coating at least partially coats the external surface or exposed surface of the green proppant. The coating can be from about 70% to about 100% of the external exposed surface area of the green proppant, for instance, from about 80% to about 100%, from about 90% to about 100%, from about 95% to about 100% of the external surface area of the green proppant.

The manner in which the green proppant can be coated with the one or more reactive agents can comprise, consist essentially of, consist of, or include spray coating, spray drying, dip coating, fluid bed coating, or any combinations thereof.

The coating of the reactive agent(s) can be achieved as a uniform or non-uniform coating. The coating can comprise, consist of, consist essentially of, or include one or multiple coatings of the same or different reactive agents.

The coating can have a maximum thickness or an average thickness of from about 1 micron to about 10 microns or more, such as from about 3 microns to about 20 microns, from about 1 micron to about 5 microns, from about 3 microns to about 10 microns, or other thicknesses. The thickness of the coating can be uniform, substantially uniform (e.g., ±20%, ±10%, ±5% with regard to variation in thickness) or the thicknesses can be non-uniform.

The reactive agent(s) can be present in an amount sufficient to control, reduce, or prevent individual proppant particles from becoming tacky and sticking together during sintering, especially sintering that involves at least liquid phrase sintering at some point during the sintering stage. The reactive agent(s) can be present in an amount of from about 0.1 wt % to about 1 wt %, from about 1 wt % to about 10 wt %, from about 1 wt % to about 5 wt %, from about 2 wt % to about 8 wt %, and other amounts above or below these ranges based on the weight of the coated green proppant.

The reactive alumina agent can have a BET surface area of from about 15 m²/g to about 150 m²/g, from about 7 m²/g to about 450 m²/g, from about 20 m²/g to about 150 m²/g, from about 7 m²/g to about 150 m²/g, or other BET surface areas above or below these ranges. The reactive zirconium agent can have the same ranges or similar ranges.

The reactive agent can be applied to the surface of the green proppant as a wet slurry or wet coating. The reactive agent can be formed into a slurry with water or other aqueous solutions. One or more organic binders, such as polyvinyl alcohol, can optionally be used. Alternatively, one or more inorganic binders, such as sodium silicate may also be used. The binder(s) can be present in an amount of from about 0.05 wt % to about 5 wt % based on the weight of the slurry. The reactive agent can be present in the slurry in an amount of from about 1 wt % to about 70 wt %, such as from 10 wt % to 75 wt %, or from 15 wt % to 70 wt %, or from 20 wt % to 60 wt %, based on the weight of the slurry. The slurry or wet coating can optionally contain other components, such as, surfactants, wetting agents, dispersants, seed crystals, and/or sintering aids.

With regard to the sintering, as indicated, the sintering generally involves at least one stage, several stages, or all stages that are liquid-phase sintering. The sintering can occur in any sintering device, such as direct or indirect rotary kilns, box furnaces, rotary batch furnaces, vertical shaft kilns, tunnel kilns, electric arc furnaces, or microwave assisted furnaces.

The sintering can occur at a temperature of from about 1,000° C. to about 1,500° C., for instance, from about 1,100° C. to about 1,400° C. The sintering can occur for any portion of time, for instance, from about 5 minutes to about 2 hours or more, 5 hours or more, 7 hours or more, 8 hours or more, 9 hours or more, 10 hours or more and the like. The sintering can occur at different temperatures for different periods of time. As indicated, the sintering will generally be at a temperature and for a time to promote and cause liquid-phase sintering to occur in the green proppant during the sintering stage.

During the sintering phrase, the reactive agent, such as the alumina agent can react with at least a portion of the aluminosilicate that is present during sintering.

With liquid-phase sintering, especially liquid-phase sintering that involves aluminosilicate, the aluminosilicate or at least a portion of the aluminosilicate, can migrate to the external surface of the green proppant, thus resulting in the particles becoming tacky. The part of the green proppant that migrates to the surface can generally be a glass phase. The reactive agent can react with the glass phase that migrates toward the surface as a liquid-phase. Without wishing to be bound to any theory, it is believed that that reactive agent (e.g., the non-alpha alumina) reacts with or pulls the silica out of this migrating glass to form an alumina-rich aluminosilicate that has significantly increased viscosity. This essentially or fully stops the migration of the liquid-phase to the surface of the proppant. The reactive agent (e.g., the non-alpha alumina), as one possibility, can react with the liquid-phase that is migrating to form a solid aluminosilicate material, such as mullite, which would stop migrating since it is in solid phase and not a liquid-phase.

The reactive agent has the ability to change the chemistry of the glass or migrating liquid-phase so that an increased viscous material is formed and/or a solid is formed. The increased viscosity can be an increase of at least 25%, at least 50%, at least 75%, at least 100%, at least 150%, at least 200%, at least 500%, or at least 1000% or more, referring to the percent change in viscosity (cPa) for the liquid-phase prior to reacting with the reactive agent (e.g., the non-alpha alumina), as compared to after reacting with the reactive agent.

If a non-reactive agent, such as a non-reactive alumina agent, such as alpha alumina, is used, the above benefits with regard to increased viscosity and controlling, reducing, or preventing surface liquid-phase formation or migration are not achieved. These non-reactive agents, such as alpha alumina, are simply physical parting agents and not reactive agents or the reactive agents of the disclosure which, to the contrary, can be considered thermo-chemical parting agents.

In some examples, once the sintering has occurred and a sintered proppant is formed, proppants that stick together or agglomerate may be significantly reduced or almost entirely reduced, or avoided in entirely. By doing so, more uniform proppants are created which has commercial importance and the wear and tear on the rotary kiln or other sintering device is greatly reduced since large agglomerates are not formed.

Thus, a proppant can be formed that comprises, consists essentially of, consists of, or includes a ceramic green proppant that comprises, consists essentially of, consists of, or includes at least aluminosilicate and includes a reactive agent(s) that is at least partially coated or fully coated on the external exposed surface of the ceramic green proppant.

Concerning the ceramic green proppant, the components that form the ceramic green proppant, as well as the morphology and other parameters as described above with regard to the method of making the ceramic proppants apply equally here with regard to the description of the proppant itself.

Examples further describe a liquid-phased sintered proppant. This proppant comprises, consists essentially of, consists of, or includes a core and at least one coating. The core comprises, consists essentially of, consists of, or includes at least aluminosilicate. The coating comprises, consists essentially of, consists of, or includes at least one reactive agent, such as at least one reactive alumina or at least one reactive zirconium (the reference to “zirconium” is a reference to compositions or compounds, that contain zirconium such that it will react with a glass phase in a proppant). One class of zirconium would be zirconia (or one or more zirconium oxides). At least a portion of the coating(s) has reacted with at least a portion of the aluminosilicate. As an example, the core can comprise, consist essentially of, consist of, or include a core and at least one shell, wherein the coating of the at least one reactive alumina agent is located on top of the shell.

Again, the various details concerning the proppant, green body, and the other components of the liquid-phase sintered proppant, described earlier for the method, apply equally here.

The proppants, while preferably used to prop open subterranean formation fractions, may be used in other technologies, such as an additive for cement or an additive for polymers, or other materials that harden, or would benefit. The proppants may also be used as encapsulated delivery systems for drugs, chemicals, and the like.

The proppants may be used to prop open subterranean formation fractions. The proppant may be suspended in a liquid phase or other medium to facilitate transporting the proppant down the well to a subterranean formation and placed such as to allow the flow of hydrocarbons out of the formation. The medium chosen for pumping the proppant can be any desired medium capable of transporting the proppant to its desired location including, but not limited to, a gas and/or liquid, energized fluid, foam, like aqueous solutions, such as water, brine solutions, and/or synthetic solutions. Any of the proppants may have a crush strength sufficient for serving as a proppant to prop open subterranean formation fractures. For instance, the crush strength can be 1,000 psi or greater, 3,000 psi or greater, greater than 4,000 psi, greater than 9,000 psi, or greater than 12,000 psi. Suitable crush strength ranges can be from about 3,000 psi to about 20,000 psi, or from about 5,000 psi to about 20,000 psi, and the like. In some applications, like coal bed methane recovery, a crush strength below 3,000 psi can be useful, such as 500 psi to 3,000 psi, or 1,500 psi to 2,000 psi.

The proppant can be suspended in a suitable gas, foam, energized fluid, or liquid phase. The carrier material, such as a liquid phase is generally one that permits transport to a location for use, such as a well site or subterranean formation. For instance, the subterranean formation can be one where proppants are used to improve or contribute to the flow of hydrocarbons, natural gas, or other raw materials out of the subterranean formation. The examples also relate to a well site or subterranean formation containing one or more proppants described herein.

The proppants may also present oil and gas producers with one or more of the following benefits: improved flow rates, improved productive life of wells, improved ability to design hydraulic fractures, and/or reduced environmental impact. The proppants may also eliminate or materially reduce the use of permeability destroying polymer gels, and/or reduce pressure drop through the proppant pack, and/or the ability to reduce the amount of water trapped between proppants thereby increasing hydrocarbon “flow area.”

The high density of conventional ceramic proppants and sands (roughly 100 lb/cu.ft.) inhibit their transport inside fractures. High density causes proppants to “settle out” when pumped thereby minimizing their efficacy. To maintain dense proppants in solution, expensive polymer gels are typically mixed with the carrier solution (e.g. completion fluid). Once suspended in a gelled completion fluid, proppant transport is considerably enhanced. Polymer gels are extremely difficult to de-cross link, however. As a result, the gel becomes trapped downhole, coats the fracture, and thereby reduces reservoir permeability. Gel-related reservoir permeability “damage factors” can range from 40% to more than 80% depending on formation type. The lightweight high strength buoyancy property that can be exhibited by the proppants may eliminate or greatly reduce the need to employ permeability destroying polymer gels, as they naturally stay in suspension. The use of extreme pressure, polymer gels, and/or exotic completion fluids to place ceramic proppants into formations adversely impacts the mechanical strength of the reservoir and shortens its economic life. Proppants may enable the use of simpler completion fluids and possibly less (or slower) destructive pumping. Thus, reservoirs packed with buoyant proppants preferably exhibit improved mechanical strength/permeability and thus increased economic life.

Enhanced proppant transport enabled by buoyancy also may enable the placement of the present proppants in areas that were heretofore impossible, or at least very difficult to prop. As a result, the mechanical strength of the formation can be improved, and can reduce decline rates over time. This benefit could be of significant importance, especially within hydraulic fractures (“water fracs”) where the ability to place proppants can be extremely limited. If neutrally buoyant proppants are employed, for example, water (fresh to heavy brines) may be used in place of more exotic completion fluids. The use of simpler completion fluids can reduce or eliminate the need to employ de-crossing linking agents. Further, increased use of environmentally friendly proppants may reduce the need to employ other environmentally damaging completion techniques such as flashing formations with hydrochloric acid. In addition to fresh water, salt water and brines, or synthetic fluids are sometimes used in placing proppants to the desired locations. These are of particular importance for deep wells.

While the term proppant has been used to identify the preferred use of the materials described herein, it is to be understood that the materials may be used in other applications. The proppant may also be used to form other products, such as, for example, matrix materials, concrete formulations, composite reinforcement phase, thermal insulating material, electrical insulating material, abrasive material, catalyst substrate and/or support, chromatography column materials (e.g., column packings), reflux tower materials (e.g., reflux tower packings, for instance, in distillation columns), and the like. The proppants may be used in medical applications, filtration, polymeric applications, catalysts, rubber applications, filler applications, drug delivery, pharmaceutical applications, and the like.

The disclosed examples have many advantages, including achieving a monodisperse distribution and/or providing enhanced conductivity and/or permeability, mechanical properties enhancement through microstructural control, and/or case strengthening by core material diffusion, and/or control over defect distribution either by elimination or filling of defects by core material during diffusion or both, and the like.

A method to make ceramic proppants is provided. The method comprises coating at least partially a green proppant with at least one reactive agent to form a coated green proppant, wherein said green proppant is a ceramic green proppant that comprises at least aluminosilicate, and sintering said coated green proppant to form a sintered proppant, wherein said sintering comprises at least liquid-phase sintering, wherein said at least one reactive agent reacts with at least a portion of a glass phase that forms during said sintering. The reactive agent may comprise at least one reactive alumina agent. The reactive agent may comprise at least one reactive zirconium agent. The reactive zirconium agent may be a compound or composition that comprises zirconium oxide, zirconium silicate or both. The sintering may occur in a rotary kiln. The reactive alumina agent may comprise less than 95% by weight alpha alumina. The reactive alumina agent may comprise less than 90% by weight alpha alumina. The reactive alumina agent may comprise less than 80% by weight alpha alumina. The reactive alumina agent may comprise less than 15% by weight alpha alumina. The reactive alumina agent may comprise smelter-grade alumina. The reactive alumina agent may comprise at least 10% by weight non-alpha alumina. The reactive alumina agent may comprise at least 15% by weight non-alpha alumina. The reactive alumina agent may comprise at least 25% by weight non-alpha alumina. The reactive alumina agent may comprise at least 50% by weight non-alpha alumina. The reactive alumina agent may be gamma alumina, delta alumina, chi alumina, eta alumina, kappa alumina, or theta alumina, or any combinations thereof. The reactive alumina agent may contain at least 30 wt % of gamma alumina. The reactive alumina agent may contain at least 70 wt % of gamma alumina. The coating may comprise spray coating, spray drying, dip coating, fluid bed coating, or any combinations thereof. The coating may be from about 70% to about 100% of the external surface area of the green proppant. The reactive alumina agent may comprise at least one non-alpha hydrated alumina. The reactive agent may have a BET surface area of from about 15 m²/g to about 150 m²/g. The reactive alumina agent may have a BET surface area of from about 7 m²/g to about 450 m²/g. The reactive alumina agent may have a BET surface area of from about 20 m²/g to about 150 m²/g. The reactive alumina agent may have a BET surface area of from about 10 m²/g to about 150 m²/g. The reactive agent may be present in an amount of from about 0.1 wt % to about 1 wt % based on the weight of said coated green proppant. The reactive agent may be present in an amount of from about 1 wt % to about 10 wt % based on the weight of said coated green proppant. The reactive agent may be present in an amount of from about 1 wt % to about 5 wt % based on the weight of said coated green proppant. The coating may have a maximum thickness or an average thickness of from about 1 micron to about 20 microns. The coating may have a maximum thickness or an average thickness of from about 3 microns to about 20 microns. The coating may have a maximum thickness or an average thickness of from about 1 micron to about 5 microns. The coating may have a maximum thickness or an average thickness of from about 3 microns to about 10 microns. At least a portion of said reactive alumina agent may react with at least a portion of said aluminosilicate during said sintering. The sintering may occur at a temperature of from about 1,000° C. to about 1,500° C. The sintering may occur at a temperature of from about 1,100° C. to about 1,400° C.

A proppant is provided. The proppant comprises a ceramic green proppant comprising at least aluminosilicate; and a reactive alumina agent that is at least partially coated on external exposed surface of said ceramic green proppant.

A liquid-phase sintered proppant is provided. The proppant comprises a core and at least one coating, wherein said core comprises at least aluminosilicate and said coating comprises at least one reactive alumina agent, and wherein at least a portion of said coating has reacted with at least a portion of said aluminosilicate. The core may comprise a core and shell.

A proppant is provided. The proppant comprises a ceramic green proppant comprising at least aluminosilicate; and a reactive zirconium agent that is at least partially coated on external exposed surface of said ceramic green proppant. The reactive zirconium agent may comprise zirconium oxide, zirconium silicate or both.

A liquid-phase sintered proppant is provided. The proppant comprises a core and at least one coating, wherein said core comprises at least aluminosilicate and said coating comprises at least one reactive zirconium agent, and wherein at least a portion of said coating has reacted with at least a portion of said aluminosilicate. The reactive zirconium agent may comprise zirconium oxide, zirconium silicate or both.

A method to make ceramic proppants is provided. The method comprises coating at least partially a green proppant with at least one reactive agent to form a coated green proppant, wherein said green proppant is a ceramic green proppant that comprises at least aluminosilicate, and sintering said coated green proppant to form a sintered proppant, wherein said sintering comprises at least liquid-phase sintering, wherein said at least one reactive agent comprises a non-alpha alumina, a zirconium oxide, a zirconium silicate, or any combinations thereof.

The disclosure also includes the following aspects/embodiments/features in any order and/or in any combination:

1. A method to make ceramic proppants comprising:

coating at least partially a green proppant with at least one reactive agent to form a coated green proppant, wherein said green proppant is a ceramic green proppant that comprises at least aluminosilicate, and

sintering said coated green proppant to form a sintered proppant, wherein said sintering comprises at least liquid-phase sintering, wherein said at least one reactive agent reacts with at least a portion of a glass phase that forms during said sintering.

2. The method of any preceding or following embodiment/feature/aspect, wherein said reactive agent comprises at least one reactive alumina agent.
3. The method of any preceding or following embodiment/feature/aspect, wherein said reactive agent comprises at least one reactive zirconium agent (i.e., reactive zirconium containing agent).
4. The method of any preceding or following embodiment/feature/aspect, wherein said reactive zirconium agent is a compound or composition that comprises zirconium oxide, zirconium silicate or both.
5. The method of any preceding or following embodiment/feature/aspect, wherein said sintering occurs in a rotary kiln.
6. The method of any preceding or following embodiment/feature/aspect, wherein said reactive alumina agent comprises less than 95% by weight alpha alumina.
7. The method of any preceding or following embodiment/feature/aspect, wherein said reactive alumina agent comprises less than 90% by weight alpha alumina.
8. The method of any preceding or following embodiment/feature/aspect, wherein said reactive alumina agent comprises less than 80% by weight alpha alumina.
9. The method of any preceding or following embodiment/feature/aspect, wherein said reactive alumina agent comprises less than 15% by weight alpha alumina.
10. The method of any preceding or following embodiment/feature/aspect, wherein said reactive alumina agent comprises smelter-grade alumina.
11. The method of any preceding or following embodiment/feature/aspect, wherein said reactive alumina agent comprises at least 10% by weight non-alpha alumina.
12. The method of any preceding or following embodiment/feature/aspect, wherein said reactive alumina agent comprises at least 15% by weight non-alpha alumina.
13. The method of any preceding or following embodiment/feature/aspect, wherein said reactive alumina agent comprises at least 25% by weight non-alpha alumina.
14. The method of any preceding or following embodiment/feature/aspect, wherein said reactive alumina agent comprises at least 50% by weight non-alpha alumina.
15. The method of any preceding or following embodiment/feature/aspect, wherein said reactive alumina agent is gamma alumina, delta alumina, chi alumina, eta alumina, kappa alumina, or theta alumina, or any combinations thereof.
16. The method of any preceding or following embodiment/feature/aspect, wherein said reactive alumina agent contains at least 30 wt % of gamma alumina.
17. The method of any preceding or following embodiment/feature/aspect, wherein said reactive alumina agent contains at least 70 wt % of gamma alumina.
18. The method of any preceding or following embodiment/feature/aspect, wherein said coating comprises spray coating, spray drying, dip coating, fluid bed coating, or any combinations thereof.
19. The method of any preceding or following embodiment/feature/aspect, wherein said coating is from about 70% to about 100% of the external surface area of the green proppant.
20. The method of any preceding or following embodiment/feature/aspect, wherein said reactive alumina agent comprises at least one non-alpha hydrated alumina.
21. The method of any preceding or following embodiment/feature/aspect, wherein said reactive agent (such as the reactive alumina agent) has a BET surface area of from about 15 m²/g to about 150 m²/g.
22. The method of any preceding or following embodiment/feature/aspect, wherein said reactive agent (such as the reactive alumina agent) has a BET surface area of from about 7 m²/g to about 450 m²/g.
23. The method of any preceding or following embodiment/feature/aspect, wherein said reactive agent (such as the reactive alumina agent) has a BET surface area of from about 20 m²/g to about 150 m²/g.
24. The method of any preceding or following embodiment/feature/aspect, wherein said reactive agent (such as the reactive alumina agent) has a BET surface area of from about 10 m²/g to about 150 m²/g.
25. The method of any preceding or following embodiment/feature/aspect, wherein said reactive agent (such as the reactive alumina agent) is present in an amount of from about 0.1 wt % to about 1 wt % based on the weight of said coated green proppant.
26. The method of any preceding or following embodiment/feature/aspect, wherein said reactive agent (such as the reactive alumina agent) is present in an amount of from about 1 wt % to about 10 wt % based on the weight of said coated green proppant.
27. The method of any preceding or following embodiment/feature/aspect, wherein said reactive agent (such as the reactive alumina agent) is present in an amount of from about 1 wt % to about 5 wt % based on the weight of said coated green proppant.
28. The method of any preceding or following embodiment/feature/aspect, wherein said coating has a maximum thickness or an average thickness of from about 1 micron to about 20 microns.
29. The method of any preceding or following embodiment/feature/aspect, wherein said coating has a maximum thickness or an average thickness of from about 3 microns to about 20 microns.
30. The method of any preceding or following embodiment/feature/aspect, wherein said coating has a maximum thickness or an average thickness of from about 1 micron to about 5 microns.
31. The method of any preceding or following embodiment/feature/aspect, wherein said coating has a maximum thickness or an average thickness of from about 3 microns to about 10 microns.
32. The method of any preceding or following embodiment/feature/aspect, wherein at least a portion of said reactive agent (such as the reactive alumina agent) reacts with at least a portion of said aluminosilicate during said sintering.
33. The method of any preceding or following embodiment/feature/aspect, wherein said sintering occurs at a temperature of from about 1,000° C. to about 1,500° C.
34. The method of any preceding or following embodiment/feature/aspect, wherein said sintering occurs at a temperature of from about 1,100° C. to about 1,400° C.
35. A proppant comprising:

a ceramic green proppant comprising at least aluminosilicate; and

a reactive agent (such as the reactive alumina agent) that is at least partially coated on external exposed surface of said ceramic green proppant.

36. A liquid-phase sintered proppant comprising a core and at least one coating, wherein said core comprises at least aluminosilicate and said coating comprises at least one reactive agent (such as the reactive alumina agent), and wherein at least a portion of said coating has reacted with at least a portion of said aluminosilicate.
37. The liquid-phase sintered proppant of any preceding or following embodiment/feature/aspect, wherein said core comprises a core and shell.
38. A proppant comprising:

a ceramic green proppant comprising at least aluminosilicate; and

a reactive zirconium agent that is at least partially coated on external exposed surface of said ceramic green proppant.

39. A liquid-phase sintered proppant comprising a core and at least one coating, wherein said core comprises at least aluminosilicate and said coating comprises at least one reactive zirconium agent, and wherein at least a portion of said coating has reacted with at least a portion of said aluminosilicate.
40. The proppant of any preceding or following embodiment/feature/aspect, wherein said reactive zirconium agent comprises zirconium oxide, zirconium silicate or both.
41. The liquid-phase sintered proppant of any preceding or following embodiment/feature/aspect, wherein said reactive zirconium agent comprises zirconium oxide, zirconium silicate or both.
42. A method to make ceramic proppants comprising:

coating at least partially a green proppant with at least one reactive agent to form a coated green proppant, wherein said green proppant is a ceramic green proppant that comprises at least aluminosilicate, and

sintering said coated green proppant to form a sintered proppant, wherein said sintering comprises at least liquid-phase sintering, wherein said at least one reactive agent comprises a non-alpha alumina, a zirconium oxide, a zirconium silicate, or any combinations thereof.

The examples can include any combination of these various features or embodiments above and/or below as set forth in sentences and/or paragraphs. Any combination of disclosed features herein is considered part of the disclosure and no limitation is intended with respect to combinable features.

To facilitate a better understanding of the present claims, the following examples of certain aspects of the disclosure are given. In no way should the following examples be read to limit, or define, the entire scope of the claims.

### EXAMPLES

### Example 1

A ceramic green proppant was formed by spray drying a plurality of particles that were present as a mixture into the shape of spheres. The ceramic green body had the following composition: bauxite, pumice, smelter-grade alumina (RC-1, Sherwin Alumina Company), calcined alumina, and clay.

The reactive alumina coating had the following composition (based on total weight of coating): 95 wt % of smelter-grade alumina (RC-1, Sherwin Alumina Company) and 5 wt % of ball clay.

For the batch of green proppants, half (by weight) of the green proppants were coated with a non-alpha alumina coating which served as the reactive alumina agent. In particular, this coating was formed from a smelter-grade alumina powder from Sherwin Alumina Company, having a particle size on average of from about 1 to about 2 microns (um). The coating was applied as a wet coating using a spray dryer. The smelter-grade alumina was applied as a slurry having a solids content of about 20 wt %, based on the weight of the slurry. The coating was applied to the green proppant so as to have an average thickness of approximately 5 microns. The entire surface of the green proppants in this divided batch, was covered by the smelter-grade alumina coating. Each batch of green proppants, the one having a coating and the one not having a coating, were subjected to sintering using a rotary kiln from Feeco, Inc. The residence time of the green proppant in the rotary kiln was about 5 to 9 hours. The sintering temperature was approximately 1,300° C., which resulted in liquid-phase sintering of the green proppants.

The sintered proppants exiting the rotary kiln were evaluated for consistent particle size and avoidance of large agglomerates. The reject rate, for the sintered proppants without the coating, was approximately 25% by weight. The reject rate of the sintered proppant having the reactive agent coating was less than about 10% by weight. Thus, using the reactive alumina agent reduced by over 100% the reject rate of the ceramic proppants being formed by the rotary kiln. FIG. 1b shows sintered proppant with the reactive alumina coating and FIG. 1a shows sintered proppant without the reactive alumina coating. There was significantly less clumping in FIG. 1b.

### Example 2-Comparative

This Example was conducted to show that an alumina coating that is an alpha alumina coating does not provide the benefits described herein in this disclosure.

A ceramic green proppant was formed by spray drying a plurality of particles that were present as a mixture into the shape of spheres. The ceramic green body had the following composition: bauxite, pumice, smelter-grade alumina (RC-1, Sherwin Alumina Company), calcined alumina, and clay.

An alpha alumina coating had the following composition (based on total weight of coating): 95 wt % of calcined alpha alumina (A-16, Almatis Inc) and 5 wt % of ball clay.

For the batch of green proppants, half (by weight) of the green proppants were coated with the alpha alumina coating in lieu of any reactive alumina agent as in Example 1. In particular, this coating was formed from a calcined alumina powder, having a particle size on average of from about 0.3 to about 0.65 micron (um). The coating was applied as a wet coating using a spray dryer. The calcined alumina was applied as a slurry having a solids content of about 20 wt %, based on the weight of the slurry. The coating was applied to the green proppant so as to have an average thickness of approximately 7 microns. The entire surface of the green proppants in this divided batch, was covered by the calcined alpha alumina coating. Each batch of green proppants, the one having a coating and the one not having a coating, were then subjected to sintering using a box furnace from Keith Company (Model #KSK-15). 10 wt % of each sample was broken and mixed in with the remaining amount of green proppant to simulate rotary kiln conditions. The residence time of the green proppant in the box furnace was from 5 to 9 hours. The sintering temperature was approximately 1,300° C., which resulted in liquid-phase sintering of the green proppants.

The sintered proppants were evaluated for consistent particle size and avoidance of large agglomerates. For the sintered proppants without any alumina coating, approximately 25% by weight was agglomerated. For the sintered proppants having the alpha alumina coating, about the same amount of sintered proppants (approximately 25% by weight) was agglomerated. Thus, using the alpha alumina coating (which was considered non-reactive) did not reduce the reject rate.

### Example 3

A ceramic green proppant was formed by spray drying a plurality of particles that were present as a mixture into the shape of spheres. The ceramic green body had the following composition: bauxite, pumice, smelter-grade alumina (RC-1, Sherwin Alumina Company), calcined alumina, and clay.

The reactive agent coating had the following composition (based on total weight of coating): 95 wt % of Alumina ZS (BPI Inc) and 5 wt % of ball clay. The Alumina ZS had zirconium oxide as the reactive agent. The Alumina ZS was a mixture of about 39 wt % zirconium oxide, about 39 wt % alpha alumina, and the balance was mullite (predominately SiO₂ in the mullite).

For the batch of green proppants, half (by weight) of the green proppants were coated with an alumina zirconia coating which served as the reactive agent. In particular, this coating was formed from a calcined alumina zirconia powder from BPI Inc, having a particle size on average of from about 1 to about 3 microns (um). The coating was applied as a wet coating using a spray dryer. The calcined alumina zirconia powder was applied as a slurry having a solids content of about 20 wt %, based on the weight of the slurry. The coating was applied to the green proppant so as to have an average thickness of approximately 5 microns. The entire surface of the green proppants in this divided batch, was covered by the reactive coating. Each batch of green proppants, the one having a coating and the one not having a coating, were subjected to sintering using a box furnace from Keith Company (Model #KSK-15). 10 wt % of each sample was broken and mixed in with the remaining amount of green proppant to simulate rotary kiln conditions. The residence time of the green proppant in the furnace was from 5 to 9 hours. The sintering temperature was approximately 1,300° C., which resulted in liquid-phase sintering of the green proppants.

The sintered proppants were evaluated for consistent particle size and avoidance of large agglomerates. For the sintered proppants without the coating, approximately 25% by weight was agglomerated. The sintered proppant having the reactive agent coating had less than 10% by weight agglomerates. Thus, using the reactive agent reduced the reject rate in lab trials by approximately 150%.

The preceding description provides various embodiments of the systems and methods of use disclosed herein which may contain different method steps and alternative combinations of components. It should be understood that, although individual embodiments may be discussed herein, the present disclosure covers all combinations of the disclosed embodiments, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the disclosure covers all combinations of all of the embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of those embodiments. If there is any conflict in the usages of a word or term in this specification and one or more patent(s) or other documents that may be incorporated herein by reference, the definitions that are consistent with this specification should be adopted.

What is claim is:

1. A method to make ceramic proppants comprising:
coating at least partially a green proppant with at least one reactive agent to form a coated green proppant, wherein said green proppant is a ceramic green proppant that comprises at least aluminosilicate, and
sintering said coated green proppant to form a sintered proppant, wherein said sintering comprises at least liquid-phase sintering, wherein said at least one reactive agent reacts with at least a portion of a glass phase that forms during said sintering.

2. The method of claim 1, wherein said reactive agent comprises at least one reactive alumina agent.

3. The method of claim 1, wherein said reactive agent comprises at least one reactive zirconium agent.

4. The method of claim 3, wherein said reactive zirconium agent is a compound or composition that comprises zirconium oxide, zirconium silicate or both.

5. The method of claim 2, wherein said reactive alumina agent comprises less than 95% by weight alpha alumina.

6. The method of claim 2, wherein said reactive alumina agent comprises smelter-grade alumina.

7. The method of claim 2, wherein said reactive alumina agent comprises at least 10% by weight non-alpha alumina.

8. The method of claim 2, wherein said reactive alumina agent is gamma alumina, delta alumina, chi alumina, eta alumina, kappa alumina, or theta alumina, or any combinations thereof.

9. The method of claim 2, wherein said reactive alumina agent contains at least 30 wt % of gamma alumina.

10. The method of claim 1, wherein said coating is from about 70% to about 100% of the external surface area of the green proppant.

11. The method of claim 2, wherein said reactive alumina agent comprises at least one non-alpha hydrated alumina.

12. The method of claim 2, wherein said reactive alumina agent has a BET surface area of from about 7 m²/g to about 450 m²/g.

13. The method of claim 1, wherein said reactive agent is present in an amount of from about 0.1 wt % to about 10 wt % based on the weight of said coated green proppant.

14. The method of claim 1, wherein said coating has a maximum thickness or an average thickness of from about 1 micron to about 20 microns.

15. A proppant comprising:
a ceramic green proppant comprising at least aluminosilicate; and
a reactive agent that is at least partially coated on external exposed surface of said ceramic green proppant.

16. The proppant of claim 15, wherein the reactive agent is alumina.

17. The proppant of claim 15, wherein the reactive agent is zirconium.

18. A method to make ceramic proppants comprising:
coating at least partially a green proppant with at least one reactive agent to form a coated green proppant, wherein said green proppant is a ceramic green proppant that comprises at least aluminosilicate, and
sintering said coated green proppant to form a sintered proppant, and wherein said sintering comprises at least liquid-phase sintering.

19. The method of claim 18, wherein the reactive agent is alumina.

20. The method of claim 18, wherein the reactive agent is zirconium.
